(19) United States
(12) Patent Application Publication
(10) Pub. No.: US 2025/0203285 A1
(43) Pub. Date: Jun. 19, 2025

(54) ACOUSTIC SYSTEM AND SIGNAL PROCESSING METHOD

(71) Applicant: SHENZHEN SHOKZ CO., LTD., Shenzhen (CN)

(72) Inventors: Chenyang WU, Shenzhen (CN); Bocheng LI, Shenzhen (CN)

(73) Assignee: SHENZHEN SHOKZ CO., LTD., Shenzhen (CN)

(21) Appl. No.: 19/063,209

(22) Filed: Feb. 25, 2025

Related U.S. Application Data
(63) Continuation of application No. PCT/CN2023/096290, filed on May 25, 2023.

(51) Int. Cl. H04R 3/04

(52) U.S. Cl. CPC H04R 3/04; H04R 2430/01

(57) ABSTRACT

An acoustic system and a signal processing method are provided. When a sounding component in the acoustic system operates, it converts a driving signal into a first sound. When a pickup component operates, it picks up ambient sound and generates a pickup signal. The ambient sound includes the first sound and a second sound from a target sound source. When operating, the signal processing circuit performs a target operation based on the driving signal and the pickup signal to generate a first target signal and sends the first target signal to the sounding component. The target operation at least includes a modulation operation and a filtering operation. The filtering operation reduces the signal component in the pickup signal that correspond to the first sound, while the modulation operation reduces the impact of nonlinear response components in the target response characteristic on the convergence performance of the filtering operation.

### RELATED APPLICATIONS

This application is a continuation application of PCT application No. PCT/CN2023/096290, filed on May 25, 2023, and the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of acoustic technology, and in particular to an acoustic system and a signal processing method.

### BACKGROUND

Some acoustic systems simultaneously include a sounding component (such as a speaker, etc.) and a pickup component (such as a sound sensor, etc.). These acoustic systems typically encounter the issue of acoustic feedback. Here, acoustic feedback refers to: the pickup signal acquired by the pickup component, after certain processing, being played through the sounding component, and the sound emitted by the sounding component being re-acquired by the pickup component, thus forming a closed-loop circuit of “sounding component→pickup component→sounding component” in the acoustic system. In such acoustic systems, the sound picked up by the pickup component from the sounding component can be referred to as feedback sound. The presence of feedback sound leads to several issues in the acoustic system. For example, it may cause the system to produce issues such as howling, and it may also limit the maximum sound gain that the acoustic system can achieve. Therefore, there is a need to provide an acoustic solution capable of reducing or eliminating feedback sound.

### SUMMARY

This disclosure provides an acoustic system that can reduce or eliminate feedback sound, thereby avoiding issues such as howling caused by feedback sound and improving the maximum forward gain that the acoustic system can achieve.

In a first aspect, this disclosure provides an acoustic system, comprising: a sounding component, which converts a driving signal into a first sound when operating; a pickup component, which picks up an ambient sound and generates a pickup signal when operating, where the ambient sound comprises the first sound and a second sound from a target sound source; and a signal processing circuit, which is connected to the sounding component and the pickup component, and when operating: executing a target operation based on the driving signal and the pickup signal to generate a first target signal, and sending the first target signal as the driving signal to the sounding component, where the target operation at least comprises a modulation operation and a filtering operation, the filtering operation reduces a signal component corresponding to the first sound in the pickup signal, and the modulation operation reduces an impact of nonlinear response components in a target response characteristic of the acoustic system on a convergence performance of the filtering operation.

In a second aspect, this disclosure provides a signal processing method, comprising, by a signal processing circuit in an acoustic system: obtaining a driving signal, where the driving signal is a signal that drives a sounding component in the acoustic system to emit a first sound; obtaining a pickup signal, where the pickup signal is obtained by a pickup component in the acoustic system picking up an ambient sound, the ambient sound comprises the first sound and a second sound from a target sound source; and performing a target operation based on the driving signal and the pickup signal to generate a first target signal, and sending the first target signal as the driving signal to the sounding component, where the target operation comprises a modulation operation and a filtering operation, the filtering operation reduces a signal component corresponding to the first sound in the pickup signal, and the modulation operation reduces an impact of nonlinear response components in target response characteristic of the acoustic system on a convergence performance of the filtering operation.

From the above technical solutions, it can be seen that the acoustic system and signal processing method provided in this disclosure involve the sounding component in the acoustic system converting the driving signal into a first sound when it operates, and the pickup component picking up ambient sound and generating the pickup signal when it operates, where the ambient sound includes the first sound and a second sound from a target sound source. The signal processing circuit is connected to both the sounding component and the pickup component, and during operation, it performs the target operation based on the driving signal and the pickup signal to generate a first target signal, which is then sent to the sounding component as the driving signal. The target operation includes at least a modulation operation and a filtering operation. Since the filtering operation reduces the signal components corresponding to the first sound in the pickup signal, the solution provided in this disclosure can reduce or eliminate feedback sound, thus avoiding issues such as howling caused by feedback sound and helping to improve the maximum sound gain that the acoustic system can achieve. Furthermore, since the modulation operation reduces the impact of nonlinear response components in the target response characteristic of the acoustic system on the convergence performance of the filtering operation, the solution provided in this disclosure can also enhance the convergence performance of the filtering operation, thereby further improving the cancellation effect of feedback sound.

Other functions of the acoustic system and signal processing method provided in this disclosure will be partially listed in the following description. The inventive aspects of the acoustic system and signal processing method provided in this disclosure can be fully explained through the practice or use of the methods, devices, and combinations described in the detailed examples below.

### BRIEF DESCRIPTION OF THE DRAWINGS

In order to more clearly illustrate the technical solutions in the embodiments of this disclosure, a brief introduction to the accompanying drawings required in the description of the embodiments is provided below. It is evident that the accompanying drawings described below are merely some exemplary embodiments of this disclosure. For a person skilled in the art, other drawings can also be obtained based on these drawings without creative effort.

FIG. 1 is a schematic diagram of an application scenario provided in some exemplary embodiments of this disclosure;

FIG. 2 is a schematic diagram of the design of an acoustic system provided in some exemplary embodiments of this disclosure;

FIG. 3 is a schematic diagram of the design of an acoustic system provided in some exemplary embodiments of this disclosure;

FIG. 4 is a schematic diagram of the design of an acoustic system provided in some exemplary embodiments of this disclosure;

FIG. 5 is a schematic diagram of the design of an acoustic system provided in some exemplary embodiments of this disclosure;

FIG. 6 is a schematic diagram of the design of an acoustic system provided in some exemplary embodiments of this disclosure;

FIG. 7 shows the test results of an acoustic system provided in some exemplary embodiments of this disclosure with respect to filtering performance;

FIG. 8 is a schematic diagram of the hardware structure of an acoustic system provided in some exemplary embodiments of this disclosure; and

FIG. 9 is a flowchart of a signal processing method provided in some exemplary embodiments of this disclosure.

### DETAILED DESCRIPTION

The following description provides specific application scenarios and requirements of this disclosure, with the aim of enabling a person skilled in the art to manufacture and use the content of this disclosure. For a person skilled in the art, various local modifications to the disclosed embodiments are apparent, and the general principles defined here can be applied to other embodiments and applications without departing from the spirit and scope of this disclosure. Therefore, this disclosure is not limited to the embodiments shown but is intended to cover the broadest scope consistent with the claims.

The terms used herein are for the purpose of describing specific example embodiments and are not meant to be restrictive. For example, unless otherwise explicitly stated in the context, the singular forms “a,” “an,” and “the” may also include the plural forms. When used in this disclosure, the terms “include,” “comprise,” and/or “contain” mean that the associated integer, step, operation, element, and/or component is present but do not exclude the presence of one or more other features, integers, steps, operations, elements, components, and/or groups, or the possibility of adding other features, integers, steps, operations, elements, components, and/or groups to the system/method.

Given the following description, these features and other features of the disclosure, as well as the operation and functionality of the related elements of the structure, and the combination and manufacturability of the parts, can be significantly improved. The accompanying drawings, which form part of this disclosure, are referenced for illustration. However, it should be clearly understood that the drawings are for illustration and description purposes only and are not intended to limit the scope of this disclosure. It should also be understood that the drawings are not drawn to scale.

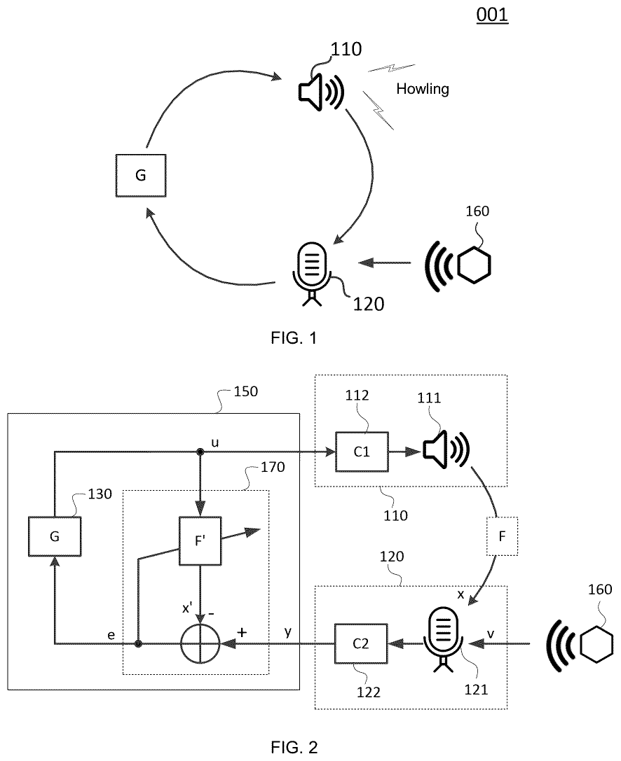

The flowcharts used in this disclosure illustrate the operations of the system implementation according to some exemplary embodiments of this disclosure. It should be clearly understood that the operations in the flowcharts may not be implemented in a specific order. Instead, the operations may be performed in reverse order or concurrently. Additionally, one or more other operations may be added to the flowcharts, or one or more operations may be removed from them. Before describing the specific embodiments of this disclosure, the application scenarios of this disclosure are introduced as follows. The technical solutions provided in this disclosure can be applied to scenarios where it is necessary to reduce or eliminate feedback sound. An example is provided below with reference to FIG. 1.

FIG. 1 shows a schematic diagram of an application scenario provided in some exemplary embodiments of this disclosure. As shown in FIG. 1, application scenario 001 can be a sound amplification scenario, an assistive listening scenario, a hearing aid scenario, etc. In this scenario, the pickup component 120 collects ambient sound during operation. In this disclosure, ambient sound refers to the sound in the environment, meaning it can include sounds emitted from all sound sources in the environment. During the pickup process, if both the sounding component 110 and the target sound source 160 are emitting sound, the ambient sound collected by the pickup component 120 includes both the sound from the target sound source 160 and the sound from the sounding component 110. Subsequently, the pickup signal collected by the pickup component 120 is sent to the sounding component 110 after being amplified by a gain (G), driving the sounding component 110 to emit sound. In this way, a “sounding component→pickup component→sounding component” closed-loop circuit is formed in the acoustic system. In this case, when sound signals at certain frequencies undergo self-excitation oscillation, howling can occur. This howling phenomenon can cause discomfort to the user, and if the howling is severe, it may also damage the components in the acoustic system. Additionally, the presence of howling limits the gain amplification factor of the acoustic system, thereby restricting the maximum sound gain the acoustic system can achieve.

It should be noted that the application scenario shown in FIG. 1 is only one of the many application scenarios to which the embodiments of this disclosure apply. The acoustic system provided in the embodiments of this disclosure can also be applied to other similar scenarios, which are not exhaustively listed in this disclosure. A person skilled in the art should understand that the solutions provided in the embodiments of this disclosure, when applied to other use cases, are also within the protection scope of the embodiments of this disclosure.

As can be seen, the presence of feedback sound leads to a series of issues in the acoustic system, including but not limited to: howling, and restricting the maximum acoustic gain that the system can achieve.

In some exemplary embodiments, the acoustic system may adopt Acoustic Feedback Cancellation (AFC) technology to reduce or eliminate feedback sound. To facilitate further description, the principle of AFC technology will be introduced with reference to FIG. 2 below.

FIG. 2 is a schematic diagram of the design of an acoustic system provided in some exemplary embodiments of this disclosure. The acoustic system 10 can be one of a hearing aid system, an assistive listening system, or a public address system. As shown in FIG. 2, the acoustic system 10 may include a sounding component 110, a pickup component 120, and a signal processing circuit 150.

Among them, the sounding component 110 is a component with a sound-emitting function. The sounding component 110 can be connected to the output port of the signal processing circuit 150, and when operating, it receives the driving signal from the signal processing circuit 150 and converts it into sound for playback. Continuing with reference to FIG. 2, the sounding component 110 may include a speaker 111 and a first peripheral circuit 112 (the first peripheral circuit is denoted as C1 in the diagram). The speaker 111 is a device used to convert electrical signals into sound and can also be referred to as an electroacoustic transducer. For example, the speaker 111 can be a loudspeaker (speaker). The first peripheral circuit 112 is connected between the output port of the signal processing circuit 150 and the speaker 110. The first peripheral circuit 112 refers to all or part of the circuits between the output port of the signal processing circuit 150 and the speaker 110. The first peripheral circuit 112 can process the electrical signal output by the signal processing circuit 150, making the processed electrical signal suitable for playback by the speaker 110. The first peripheral circuit 112 can include at least one first peripheral component, which may include, but is not limited to, operational amplifiers, power amplifiers, digital-to-analog converters, filters, tuners, capacitors, resistors, inductors, chips, and other components.

It should be noted that the speaker 111 can be a device that emits sound based on at least one of the conduction methods of gas, liquid, or solid. This disclosure does not limit this aspect. The speaker 111 can be the horn itself, or it may include the horn and its associated simple circuit components. The number of speakers 111 can be one or more. When the number of speakers 111 is multiple, the multiple speakers 111 can be arranged in an array form. Additionally, when the number of speakers 111 is multiple, the multiple speakers 111 can be connected to the signal processing circuit 150 through the same first peripheral circuit 112, or the multiple speakers 111 can also be connected to the signal processing circuit 150 through different first peripheral circuits 112.

The pickup component 120 is a component with a sound-picking function. The pickup component 120 can be connected to the input port of the signal processing circuit 150, and when operating, it picks up ambient sound to generate a pickup signal, which is then sent to the signal processing circuit 150. Continuing with reference to FIG. 2, the pickup component 120 may include at least one sound sensor 121 and a second peripheral circuit 122 (the second peripheral circuit is denoted as C2 in the diagram). The sound sensor 121 is a device used to pick up sound and convert the sound into an electrical signal, which can also be referred to as an electroacoustic transducer. For example, the sound sensor 121 can be a microphone (MIC). The second peripheral circuit 122 is connected between the sound sensor 121 and the input port of the signal processing circuit 150. The second peripheral circuit 122 refers to all or part of the circuits between the sound sensor 121 and the input port of the signal processing circuit 150. The second peripheral circuit 122 may process the electrical signal (i.e., the pickup signal) picked up by the sound sensor 121, so that the signal is converted into a form suitable for processing by the signal processing circuit 150. The second peripheral circuit 122 can include at least one second peripheral component, which may include, but is not limited to, power amplifiers, operational amplifiers, analog-to-digital converters, filters, tuners, capacitors, resistors, inductors, chips, and other components.

It should be noted that the sound sensor 121 can be a device that picks up sound based on at least one of the conduction methods of gas, liquid, or solid. This disclosure does not limit this aspect. The sound sensor 121 can be the MIC itself, or it may include the MIC and its associated simple circuit components. The number of sound sensors 121 can be one or more. When the number of sound sensors 121 is multiple, the multiple sound sensors 121 can be arranged in an array form. Additionally, when the number of sound sensors 121 is multiple, the multiple sound sensors 121 can be connected to the signal processing circuit 150 through the same second peripheral circuit 122, or the multiple sound sensors 121 can also be connected to the signal processing circuit 150 through different second peripheral circuits 122.

Continuing with reference to FIG. 2, the operation process of the acoustic system 10 is as follows: The pickup component 120 collects ambient sound to generate a pickup signal y, which is input into the signal processing circuit 150. The ambient sound at least includes the second sound emitted by the target sound source 160. The target sound source 160 refers to any sound source other than the sounding component 110. For example, the target sound source 160 may include electronic devices with sound playback functions (such as TVs, speakers, smartphones, etc.); or the target sound source 160 may also include a human throat. The above pickup signal y can be referred to as the input signal of the signal processing circuit 150. The signal processing circuit 150 processes the pickup signal y and obtains the driving signal u, which is then sent to the sounding component 110. The driving signal u can be referred to as the output signal of the signal processing circuit 150. The sounding component 110 receives the driving signal u and converts it into the first sound. After passing through the feedback path, the first sound is re-collected by the sound sensor 120. Therefore, the first sound can also be referred to as feedback sound. Thus, the ambient sound collected by the pickup component 120 not only includes the second sound from the target sound source 160, but also includes the first sound from the sounding component 110. In other words, the pickup signal y contains both the signal component x corresponding to the first sound (i.e., feedback sound) and the signal component v corresponding to the second sound.

The signal processing circuit 150 can be a circuit with certain signal processing capabilities. The input port of the signal processing circuit 150 is connected to the pickup component 120, and the output port is connected to the sounding component 110. Inside the signal processing circuit 150, the driving signal u can be obtained, and the pickup signal y can be received from the pickup component 120. Then, based on the driving signal u and pickup signal y, the target operation is executed to generate the first target signal, which is sent as the new driving signal (i.e., the driving signal u for the next moment) to the sounding component 110.

The target operation includes at least the filtering operation. The filtering operation is configured to reduce the signal components in the pickup signal y corresponding to the first sound. In other words, the filtering operation can reduce the feedback component in the pickup signal y. The filtering operation can include adaptive filtering. For example, the adaptive filtering operation can be a filtering operation based on the AFC technology. Below, the principle of AFC-based filtering operation will be explained in detail with reference to FIG. 2.

Continuing with reference to FIG. 2, the signal processing circuit 150 can include a filtering unit 170. The input to the filtering unit 170 includes the driving signal u and the pickup signal y. The filtering unit 170 can reduce the signal components in the pickup signal y corresponding to the first sound based on the driving signal u, thereby obtaining signal e. Specifically, assume the acoustic transfer function from the speaker 111 to the sound sensor 121 is F. Internally, the filtering unit 170 can solve and adaptively update a time-varying transfer function F′ to fit F. For distinction, the transfer function F′ is referred to as the predicted transfer function F′; and F is referred to as the real transfer function F. The filtering unit 170 uses the predicted transfer function F′ to perform adaptive filtering on the driving signal u to obtain signal x′, i.e., x′=u*F′. Signal x′ can be considered the predicted value of the feedback component (i.e., the signal component in the pickup signal y corresponding to the first sound). Then, the filtering unit 170 can subtract signal x′ from the pickup signal y to obtain signal e, i.e., e=y−x′. The signal e obtained in this manner contains little to no feedback sound components.

It should be noted that the filtering unit 170 can use various adaptive filtering algorithms to solve for the predicted transfer function F′, such as Least Mean Square (LMS), Normalized Least Mean Square (NLMS), Recursive Least Squares (RLS), or a combination of one or more of these methods. The embodiments of the present disclosure are not limited to any specific algorithm. Additionally, the adaptive filtering algorithm can be performed in the time domain, frequency domain, or other transform domains.

The target operation can also include a gain amplification operation. Continuing with reference to FIG. 2, the signal processing circuit 150 can also include a gain amplification unit 130. The gain amplification unit 130 can perform a gain amplification operation on the signal e to obtain the first target signal. The signal processing circuit 150 sends the first target signal as the next moment's driving signal u to the sounding component 110 to drive the sounding component 110 to produce sound.

According to the theory of adaptive filtering algorithms, the update of the predicted transfer function F′ can be achieved by minimizing the expectation of the mean square function of signal e, i.e.:

$${min}_{{F}^{′}} E [ {e}^{2} ] = {min}_{{F}^{′}} E [ {( y - u * {F}^{′} )}^{2} ] \qquad Formula ( 1 - 1 )$$

For example, taking the LMS algorithm as the filtering unit 170, based on the gradient descent optimization method, the update formula for the predicted transfer function F′ derived from the above equation (1-1) is as follows:

$${F}^{′} ← {F}^{′} + μ * e * u \qquad Formula ( 2 - 1 )$$

Where μ is the iteration step size.

It should be understood that when the filtering unit 170 uses algorithms such as NLMS, RLS, etc., a similar method can be used to derive the update formula for the predicted transfer function F′. The present disclosure does not provide individual examples of this.

In summary, the acoustic system shown in FIG. 2 can reduce or eliminate feedback sounds by performing AFC-based filtering operations, thereby avoiding issues like squealing caused by feedback sounds and helping to increase the maximum sound gain achievable by the acoustic system.

According to signal processing theory, the closed-loop gain A of the acoustic system shown in FIG. 2 can be expressed as follows:

$$A = \frac{u}{v} = \frac{G}{1 - G ( F - {F}^{′} )} \qquad Formula ( 3 - 1 )$$

According to the Nyquist stability criterion, the requirement for an acoustic system to cancel feedback sound is that the solved predicted transfer function F′ must exactly match the real transfer function F, i.e., F′=F. When this condition is met, the acoustic system will always remain stable, without producing squealing, and the system will be able to achieve infinite gain, i.e., when G→∞, A=G→∞.

However, in practical acoustic systems, since the real transfer function F may be time-varying, and the iterative solution process may oscillate, the iteration process of F′ is unlikely to achieve the ideal condition of F′=F. In other words, there will always be some deviation between the predicted transfer function F′ obtained through iteration and the real transfer function F. In this case, in order to keep the acoustic system stable, the gain G provided by the gain amplification unit 130 cannot be infinite. Therefore, the maximum gain achievable by the acoustic system is:

$${G}_{max} = \frac{1}{\vert F - {F}^{′} \vert} \qquad Formula ( 4 )$$

From equation (4), it can be seen that the deviation between the predicted transfer function F′ and the actual transfer function F can be used to measure the convergence performance of the adaptive filtering algorithm, and further measure the acoustic system's ability to cancel the feedback sound. Specifically, if the deviation between the predicted transfer function F′ and the actual transfer function F is smaller, it indicates that the convergence performance of the adaptive filtering algorithm is better, and thus the acoustic system's ability to cancel the feedback sound is better. If the deviation between the predicted transfer function F′ and the actual transfer function F is larger, it indicates that the convergence performance of the adaptive filtering algorithm is worse, and thus the acoustic system's ability to cancel the feedback sound is worse.

In some exemplary embodiments, we can also use the misalignment quantity (MIS) to measure the convergence performance of the adaptive filtering algorithm. The misalignment quantity MIS can be expressed by the following formula:

$$MIS = 20 {log}_{10} \frac{\vert {F}^{′} - F \vert}{\vert F \vert} \qquad Formula ( 5 )$$

The misalignment (MIS) is measured in decibels (dB). When the predicted transfer function F′ is initialized to zero, the misalignment MIS is 0 dB. As the misalignment MIS decreases and approaches negative infinity, the deviation between the predicted transfer function F′ and the actual transfer function F becomes smaller, indicating better convergence performance of the adaptive filtering algorithm, and thus better feedback sound cancellation by the acoustic system. Conversely, as the misalignment MIS increases and approaches positive infinity, the deviation between the predicted transfer function F′ and the actual transfer function F becomes larger, indicating poorer convergence performance of the adaptive filtering algorithm, and consequently worse feedback sound cancellation by the acoustic system.

It should be noted that the convergence performance of the adaptive filtering algorithm in this disclosure includes, but is not limited to, factors such as convergence speed and convergence error. Specifically, the convergence speed refers to the rate at which the predicted transfer function F′ fits the actual transfer function F, while the convergence error refers to the deviation between the predicted transfer function F′ and the actual transfer function F when the convergence condition is met.

In the acoustic system shown in FIG. 2, the reason why an adaptive filtering algorithm can be used to solve a time-varying predicted transfer function F′ to fit the actual transfer function F is because the transfer effects of the sounding component 110 and the pickup component 120 are ignored, or in other words, it is assumed that the sounding component 110 and the pickup component 120 are ideal linear transducers. That is, it is assumed that the transfer function of the sounding component 110 is 1 (or a constant k₁), and the transfer function of the pickup component 120 is 1 (or a constant k₂). For simplicity, in the following description, the transfer functions of the ideal linear transducers are all described as 1.

However, in practical acoustic systems, the above assumption is generally not valid. The following is an analysis of the actual acoustic system. Let the transfer function of the sounding component 110 be denoted as F_{SPK}, and the transfer function of the pickup component 120 be denoted as F_{MIC}. At this point, the closed-loop gain A of the acoustic system shown in FIG. 2 can be expressed as follows:

$$A = \frac{u}{v} = \frac{G * {F}_{MIC}}{1 - G ( {F}_{SPK} * F * {F}_{MIC} - {F}^{′} )} \qquad Formula ( 3 - 2 )$$

According to the Nyquist stability criterion, the requirement for an acoustic system to cancel feedback sound is that the solved predicted transfer function F′ needs to fit the combined transfer effect of F_{SPK}, F, and F_{MIC}, that is, F′=F_{SPK}*F*F_{MIC}

In practical acoustic systems, the pickup component 120 typically includes a sound sensor 121 and a second peripheral circuit 122. The devices in the sound sensor 121 and the second peripheral circuit 122 have good linear response within the typical audio signal dynamic range. Therefore, based on signal processing theory, under the assumption of short-time stationarity, the transfer effect of the pickup component 120 can be approximated as negligible. That is to say, the transfer function F_{MIC} of the pickup component 120 can be regarded as 1.

The sounding component 110 typically includes a speaker 111 and a first peripheral circuit 112. The interaction between the diaphragm and the magnet of the speaker 111 leads to hysteresis effects and saturation distortion, among others. Therefore, the response of the speaker 111 contains nonlinear response components. The first peripheral circuit 112 generally includes devices such as power amplifiers and operational amplifiers. Power amplifiers and operational amplifiers typically exhibit clipping effects, so their responses also contain nonlinear components. Similarly, other devices in the first peripheral circuit 112 may also have nonlinear response components. Thus, the transfer function F_{SPK} of the sounding component 110 contains nonlinear response components.

In the solution shown in FIG. 2, since the filtering unit 170 obtains the driving signal u before the output port of the signal processing circuit 150 and applies adaptive filtering to the driving signal u using the predicted transfer function F′, the nonlinear response components of the transfer function F_{SPK} of the sounding component 110 are inevitably introduced into the iterative solution of the predicted transfer function F′. Adaptive filtering algorithms are generally suited for tracking time-varying linear systems, and the introduction of these nonlinear response components will lead to poor convergence performance of the adaptive filtering algorithm, for example, causing the predicted transfer function F′ to fail to converge, converge slowly, or exhibit large convergence errors. This causes the misalignment index MIS of the acoustic system to deteriorate, thereby affecting the acoustic system's ability to cancel feedback sound.

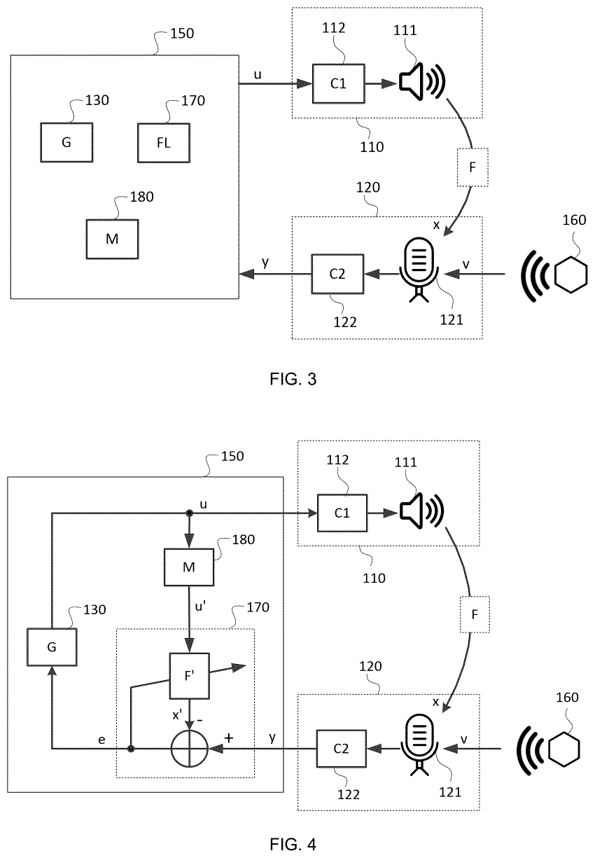

To address this, the solution provided in the embodiments of this disclosure introduces a modulation operation inside the signal processing circuit 150 to reduce the impact of the nonlinear response components on the convergence performance of the filtering operation. The following is a detailed description with reference to FIGS. 3 to 6.

FIG. 3 is a schematic diagram of the design of an acoustic system provided in some exemplary embodiments of this disclosure. Referring to FIG. 3, the signal processing circuit 150 may also include a modulation unit 180. The modulation unit 180 is configured to perform a modulation operation. That is, the target operations performed by the signal processing circuit 150 include filtering, modulation, and gain amplification operations. It should be noted that the specific implementations of the filtering unit 170 and the gain amplification unit 130 can be referenced in the related description of FIG. 2 and will not be repeated here.

The modulation unit 180 can modulate the signal to reduce the impact of the nonlinear response components in the target response characteristic of the acoustic system on the convergence performance of the filtering operation.

Specifically, the target response characteristic can represent the response characteristics of N target devices in the acoustic system, where N is an integer greater than or equal to 1. As described earlier, the first peripheral circuit 112 can include at least one first peripheral device, and the second peripheral circuit 122 can include at least one second peripheral device. The N target devices can include the speaker 111, the sound sensor 121, at least one first peripheral device, or at least one second peripheral device. That is to say, the target response characteristic can represent the response characteristics of at least one device selected from the speaker 111, the sound sensor 121, at least one first peripheral device, and at least one second peripheral device. It can be understood that when the value of N is greater than 1, the target response characteristic actually represents the response of the system formed by considering the N target devices as a whole.

In the embodiments of this disclosure, the response characteristic of device A refers to the characteristic that represents the relationship between the output signal and the input signal of device A. For example, suppose the input signal of device A is denoted as Sᵢₙ and the output signal is denoted as Sₒᵤₜ. The mathematical expression/model representing the relationship between Sₒᵤₜ and Sᵢₙ can be regarded as the response characteristic of device A. If the output signal Sₒᵤₜ and the input signal Sᵢₙ of device A are related linearly, it means that device A exhibits a linear response. If the output signal Sₒᵤₜ and the input signal Sᵢₙ of device A are related nonlinearly, it means that device A exhibits a nonlinear response. In some cases, the response characteristic of device A can include both linear response components and nonlinear response components. It should be noted that when the response characteristic of device A includes nonlinear response components, the number of these nonlinear response components can be one or more. For example, suppose the response characteristic of device A can be written as: Sₒᵤₜ=f₁(Sᵢₙ)+f₂(Sᵢₙ)+f₃(Sᵢₙ) where f₁ is the linear response component, and f₂ and f₃ are the nonlinear response components. This indicates that the response characteristic of device A includes both a linear response component and two nonlinear response components.

Since the target response characteristic represents the response characteristics of the N target devices, when at least one of the target devices in the N target devices has a response characteristic that includes nonlinear response components, the target response characteristic will also include nonlinear response components. It should be noted that the number of nonlinear response components included in the target response characteristic can be one or more. For convenience, in the following descriptions, it is assumed that the target response characteristic includes M nonlinear response components, where M is an integer greater than or equal to 1. It can be understood that, in addition to the M nonlinear response components, the target response characteristic can also include linear response components.

As mentioned earlier, when the response characteristics of at least one of the devices in the speaker 111, sound sensor 121, first peripheral circuit 112 (i.e., at least one first peripheral device), or second peripheral circuit 122 (i.e., at least one second peripheral device) contain nonlinear response components, these nonlinear response components will affect the convergence performance of the filtering operation (e.g., an AFC-based adaptive filtering operation). Therefore, in the acoustic system shown in FIG. 3, the modulation operation performed by the modulation unit 180 can be a modulation operation based on the nonlinear response components in the target response characteristic. In this way, by performing the modulation operation, the modulation unit 180 can reduce the impact of the nonlinear response components on the convergence performance of the filtering operation, thereby improving the convergence performance of the filtering operation and enhancing the acoustic system's ability to cancel feedback sound.

In some exemplary embodiments, considering that the response characteristics of the sound sensor 121 and the second peripheral circuit 122 generally do not contain or contain fewer nonlinear response components, while the response characteristics of the speaker 111 and the first peripheral circuit 112 typically contain nonlinear response components or contain more nonlinear response components, the target response characteristic can represent the response characteristic of the speaker 111. Alternatively, the target response characteristic can represent the response characteristic of at least one first peripheral device (e.g., the power amplifier, operational amplifier, etc., in the first peripheral circuit 112). Alternatively, the target response characteristic can represent the response characteristic of the speaker 111 and at least one first peripheral device.

The modulation operation performed by the modulation unit 180 can include at least one of amplitude modulation, phase modulation, frequency modulation, and filter modulation.

In this context, amplitude modulation refers to a method of modulating the amplitude of a signal. It should be noted that there are various methods for modulating the amplitude of a signal, and this disclosure does not limit this. For example, the amplitude of the signal to be modulated can be clipped to achieve modulation.

The phase modulation refers to a method of modulating the phase of a signal. It should be noted that there are various methods for modulating the phase of a signal, and this disclosure does not limit this. For example, the phase of the signal to be modulated can be varied to achieve modulation.

Frequency modulation refers to a method of modulating the frequency of a signal. It should be noted that there are various methods for modulating the frequency of a signal, and this disclosure does not limit this. For example, the frequency of the signal to be modulated can be changed to achieve modulation.

Filter modulation refers to a method of achieving modulation by filtering the signal. It should be noted that there are various ways of filtering a signal, and this disclosure does not limit this. For example, the signal to be modulated can be input into a preset filter to achieve modulation.

When the modulation unit 180 performs the modulation operation, it can adopt one or more of amplitude modulation, phase modulation, frequency modulation, and filter modulation. When the modulation unit 180 uses multiple modulation methods, the modulation of the signal can be more flexible, which can meet the modulation needs of different scenarios.

Based on the solution shown in FIG. 3, when designing the modulation operation performed by the modulation unit 180, it can be designed from different modulation principle dimensions. Below, two possible modulation principles are provided as examples for illustration.

Modulation Principle 1: The modulation operation is configured to simulate the nonlinear response components in the target response characteristic.

Specifically, suppose the target response characteristic includes at least M nonlinear response components, where M is an integer greater than or equal to 1. When performing the modulation operation, the modulation unit 180 can modulate the signal to be modulated by simulating the M nonlinear response components.

The M nonlinear response components can originate from the N target devices in the acoustic system. That is to say, the M nonlinear response components are introduced by the N target devices, where N is an integer greater than or equal to 1. As mentioned earlier, the N target devices can include at least one of the speaker 111, the sound sensor 121, the first peripheral circuit 112, and the second peripheral circuit 122. In this case, the nonlinear response characteristics of the N target devices can be modeled in advance to obtain a target response model. The target response model can be a mathematical expression used to characterize the nonlinear response characteristics of the N target devices. This mathematical expression can take the form of a neural network, a function, or other possible forms. The target response model is used to replicate the nonlinear response characteristics of the N target devices.

For example, suppose signal S1 is input into the target response model to obtain signal S2. Then, signal S2 can be regarded as “the result signal containing M nonlinear response components after the N target devices process the signal S1.”

When modeling the nonlinear response characteristics of the N target devices, either joint modeling or individual modeling can be used. The two modeling methods will be described below.

### (1) Joint Modeling Method

During the operation of the acoustic system, the response data of the N target devices can be measured. The response data of each target device can include output data corresponding to different values of input variables, where the input variables include, but are not limited to: operating time, operating frequency, input signal amplitude, supply voltage, temperature, humidity, and so on. Furthermore, the response data of the N target devices can be jointly modeled to obtain the target response model. Specifically, based on the response data of the N target devices, the deviation statistics of the response characteristics of the N target devices relative to the ideal linear components are analyzed.

These deviation statistics can include, but are not limited to, clipping distortion, harmonic distortion, intermodulation distortion, cross-frequency distortion, repeatability, hysteresis, and at least one dimension of resolution statistics. Subsequently, the response data for which the deviation statistics exceed the preset threshold value can be modeled to obtain the target response model.

It should be understood that the target response model obtained using the joint modeling method simulates the nonlinear response characteristics under the combined effect of the N target devices.

### (2) Individual Modeling Method

During the operation of the acoustic system, the response data of the N target devices can be measured. Subsequently, the response data of each target device can be modeled separately to obtain a sub-response model corresponding to each target device. It should be understood that the specific modeling method for each target device is similar to the joint modeling method, which will not be elaborated here. The difference between the individual modeling method and the joint modeling method is that the individual modeling method involves modeling each target device separately, while the joint modeling method treats the N target devices as a whole for modeling.

When using the individual modeling method, a sub-response model can be obtained for each target device. Therefore, in this case, the target response model actually consists of N sub-response models corresponding to the N target devices. Each sub-response model simulates the nonlinear response characteristics of a single target device. Hence, when using the target response model, the N sub-response models can be sequentially connected to simulate the nonlinear response characteristics of the N target devices.

After the target response model is obtained, when the modulation unit 180 performs the modulation operation, it can simulate the M nonlinear response components through the target response model to modulate the signal to be modulated. Specifically, the modulation unit 180 can input the signal to be modulated into the target response model, where the target response model modulates the signal and outputs the modulated signal.

Based on the modulation principle of the above modulation operation, the process of performing the target operation by the signal processing circuit 150 will be illustrated below with reference to FIG. 4.

FIG. 4 is a schematic diagram of the design of an acoustic system provided in some exemplary embodiments of this disclosure. As shown in FIG. 4, the modulation unit 180 can be located on the branch where the filtering unit 170 is located. In this case, the process of performing the target operation by the signal processing circuit 150 is as follows:
(1) The signal processing circuit 150 outputs a driving signal u and obtains a pickup signal y from the pickup component 120.
(2) The driving signal u is used as the signal to be modulated, and the modulation operation is performed to obtain the modulated signal u′. For example, the driving signal u is input into the target response model to obtain the modulated signal u′. That is, u′=u*M.

Herein, M represents the transfer function corresponding to the modulation operation, or in other words, M represents the target response model.
(3) Based on the modulated signal u′, the filtering operation is performed on the pickup signal y to obtain the residual signal e.

Specifically, referring to FIG. 4, the modulated signal u′ is adaptively filtered using the predicted transfer function F′ to obtain the signal x′, that is, x′=u′ *F′. The signal x′ can be considered as the predicted value of the feedback component (i.e., the signal component in the pickup signal y corresponding to the first sound). Then, subtracting the signal x′ from the pickup signal y yields the residual signal e. That is, e=y−x′=y−u′*F′=y−(u*M)*F′. The resulting residual signal e contains little to no feedback sound components.
(4) The residual signal e undergoes the gain amplification operation to obtain the first target signal (i.e., the driving signal u for the next time moment), that is, u=e*G.

Next, the update method of the predicted transfer function F′ in the solution shown in FIG. 4 will be explained. According to the theory of adaptive filtering algorithms, the update method of the predicted transfer function F′ can be achieved by minimizing the expected value of the mean square function of the residual signal e, that is:

$${min}_{{F}^{′}} E [ {e}^{2} ] = {min}_{{F}^{′}} E [ {( y - ( u * M ) * {F}^{′} )}^{2} ] \qquad Formula ( 1 - 2 )$$

Still taking the LMS algorithm used in filter unit 170 as an example, based on the gradient descent optimization method, the update formula for the predicted transfer function F′ derived from the above formula (1-2) is as follows:

$${F}^{′} ← {F}^{′} + μ * e * ( u * M ) \qquad Formula ( 2 - 2 )$$

It can be seen that after the signal processing circuit 150 obtains the first target signal u, it can also perform the modulation operation on the first target signal u to obtain the second target signal (i.e., u*M). Then, according to the above formula (2-2), the predicted transfer function F′ is updated based on the second target signal (i.e., updating the parameters of the filtering operation), to cause the filtering operation to converge.

In the solution shown in FIG. 4, the process by which the modulation unit 180 performs the modulation operation is equivalent to simulating the “nonlinear response process of the N target devices to the driving signal u.” It can be understood that when the N target devices include all the devices in the sounding component 110 and pickup component 120, the modulation operation simulates all the nonlinear response components in the feedback path, and the predicted transfer function F′ is only responsible for tracking the linear response components in the feedback path. When the N target devices include some of the devices in the sounding component 110 and pickup component 120, the modulation operation simulates at least part of the nonlinear response components in the feedback path, and the predicted transfer function F′ needs to be responsible for tracking both the linear response components and the remaining nonlinear response components in the feedback path. Thus, the nonlinear response components are either not introduced or are introduced to a lesser extent in the solution of the predicted transfer function F′, which improves the convergence performance of the filtering operation and enhances the effectiveness of feedback sound cancellation.

In is noted that in the scheme shown in FIG. 4, it should be noted that when the modulation unit 180 performs the modulation operation, the target response model simulates the nonlinear response components in the target response characteristic. In some cases, the target response characteristic may include both nonlinear and linear response components. For the linear response components, the target response model can either simulate them or not simulate them.

In the case where the target response model does not simulate the linear response components, these linear response components will be fitted into the predicted transfer function F′ together with the acoustic transfer function F. In other words, the predicted transfer function F′ ultimately fits the combined effect of the transfer function F and the linear response components.

In the case where the target response model simulates the linear response components, it is assumed that the modulation operation fully simulates the transfer function F_{SPK} of the sounding component 110 and the transfer function F_{MIC} of the pickup component 120, i.e., M=F_{SPK}*F_{MIC}. In this case, the closed-loop gain A of the acoustic system can be expressed as follows:

$$A = \frac{u}{v} = \frac{G * {F}_{MIC}}{1 - G ( {F}_{SPK} * F * {F}_{MIC} - M * {F}^{′} )} = \frac{G * {F}_{MIC}}{1 - G * {F}_{SPK} * {F}_{MIC} ( F - {F}^{′} )} \qquad Formula ( 3 - 4 )$$

From formula (3-4), it can be seen that the predicted transfer function F′ ultimately fits the acoustic transfer function F between the speaker 111 and the sound sensor 121. This reduces the tracking pressure on F_{SPK} and F_{MIC} by the predicted transfer function F′.

Modulation principle 2: The modulation operation is configured to modulate the input signal in a way that the modulated signal operates within the linear response range of the target device.

Taking device A as an example, let's illustrate the meaning of the linear response range. Assume that device A is an ideal linear device, which means that device A exhibits a linear response to any input variable (such as time, frequency, amplitude, phase, temperature, humidity, etc.). However, in actual acoustic scenarios, this ideal assumption is often not met. Typically, device A exhibits linear response only under certain conditions. For example, when the input variable X1 is within the first range, device A shows a linear response, and when the input variable X1 is in other ranges, device A exhibits a nonlinear response. In this case, the first range of the input variable X1 can be considered the linear response range for device A. Similarly, if device A exhibits a linear response when input variable X2 is in the second range, and a nonlinear response in other ranges, the second range of the input variable X2 can be considered the linear response range for device A. It is important to note that, in practical applications, the linear response range corresponding to different input variables for device A may either overlap or differ.

The target response characteristic may include linear features. The linear features correspond to the linear response range of N target devices in the acoustic system, where N is an integer greater than or equal to 1. As mentioned earlier, the N target devices may include at least one device from the group consisting of speaker 111, sound sensor 121, first peripheral circuit 112, and second peripheral circuit 122. “The linear features correspond to the linear response range of N target devices in the acoustic system” means that when a certain signal satisfies the linear features, the N target devices will exhibit linear response when processing the signal, or in other words, the N target devices will operate in linear response mode. The linear features may include at least one value range corresponding to each input variable. For example, the linear features may include: at least one value range from the amplitude range [A1, A2], frequency range [f1, f2], phase range [w1, w2], temperature range [t1, t2], humidity range [H1, H2], and time range [T1, T2].

The linear features can be obtained by modeling the linear response of the N target devices in advance. During the modeling process, a joint modeling approach can be used, or a separate modeling approach can be employed. The two modeling approaches will be introduced separately below.

### (1) Joint Modeling Method

During the operation of the acoustic system, the response data of the N target devices can be measured. The response data of each target device may include output data corresponding to different values of the input variables, where the input variables include but are not limited to: continuous operating time, operating frequency, input signal amplitude, supply voltage, temperature, humidity, and other data. Furthermore, the response data of the N target devices can be jointly modeled to obtain the linear features. Specifically, based on the response data of the N target devices, an analysis is conducted to determine the deviation statistics of the response of the N target devices relative to an ideal linear component when the values of the input variables fall within different range intervals. The deviation statistics may include but are not limited to clipping distortion, harmonic distortion, intermodulation distortion, intermodulation distortion, repeatability, hysteresis, and at least one dimension of resolution statistics. For example, when the amplitude is within the range [A1, A2] and the frequency is within the range [f1, f2], the deviation statistics of the response of the N target devices relative to an ideal linear component are less than a preset threshold. In this case, the linear features obtained by modeling include: amplitude range [A1, A2] and frequency range [f1, f2].

It should be understood that the linear features obtained using the joint modeling approach take into account the linear response under the combined effect of the N target devices. In other words, when a signal satisfies the linear features, the signal will cause all N target devices to operate in the linear response mode.

### (2) Individual Modeling Method

During the operation of the acoustic system, the response data of the N target devices can be measured. Subsequently, the response data of each target device can be individually modeled to obtain the sub-signal features corresponding to that target device, thereby obtaining N sub-signal features corresponding to the N target devices. Each sub-signal feature includes at least one value range corresponding to an input variable. It should be understood that when modeling each target device separately, the specific modeling method is similar to the joint modeling approach and will not be elaborated here. Furthermore, the linear features can be determined based on the N sub-signal features. For example, an intersection operation or other operations can be performed on the value ranges of the N sub-signal features to obtain the linear features.

After the linear features are obtained through modeling, the modulation unit 180 can modulate the signal to be modulated based on the linear features when performing the modulation operation, so that the modulated signal corresponds to the linear response range of the N target devices. In other words, the purpose of the modulation operation is to ensure that the modulated signal satisfies the value ranges specified by the linear features. For example, the modulation unit 180 may adjust the signal to be modulated using at least one of amplitude modulation, phase modulation, frequency modulation, or filter modulation so that the modulated signal meets the data range specified by the linear features. In this way, when the modulated signal is processed by the N target devices, the N target devices will operate in the linear response mode rather than entering the nonlinear response mode.

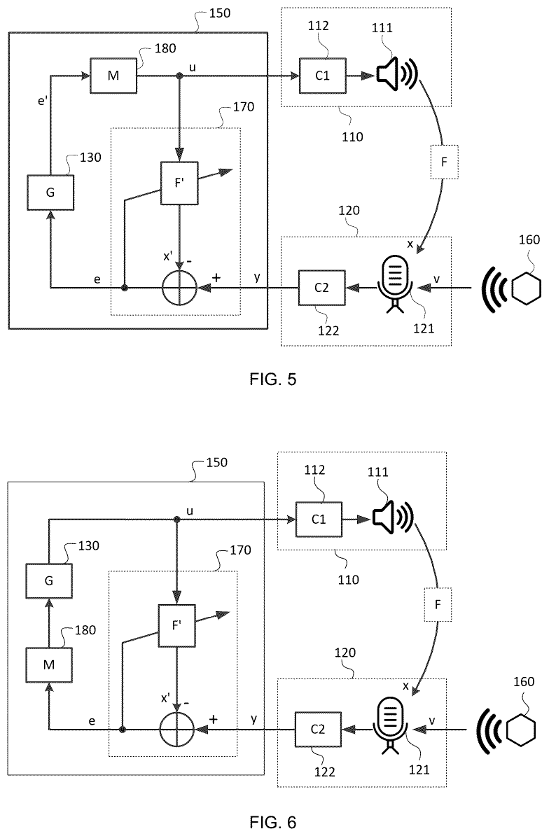

Based on the modulation principle of the above modulation operation, the following provides an example of the process in which the signal processing circuit 150 performs the target operation, in conjunction with FIGS. 5 and 6.

FIG. 5 is a schematic diagram of the design of an acoustic system provided in some exemplary embodiments of this disclosure. As shown in FIG. 5, the modulation unit 180 may be located after the gain amplification unit 130 and before the extraction position of the driving signal u. In this case, the process in which the signal processing circuit 150 performs the target operation is as follows:
(1) The signal processing circuit 150 obtains the driving signal u internally and acquires the pickup signal y from the pickup component 120.
(2) Based on the driving signal u, the filtering operation is performed on the pickup signal y to obtain the error signal e.

Specifically, referring to FIG. 5, the predictive transfer function F′ is used to perform adaptive filtering on the driving signal u to obtain the signal x′, i.e., x′=u*F′. The signal x′ can be regarded as the predicted value of the feedback component in the pickup signal y (i.e., the signal component in the pickup signal y corresponding to the first sound). Subsequently, the signal x′ is subtracted from the pickup signal y to obtain the error signal e, i.e., e=y−x′=y−u*F′. In this way, the obtained error signal e does not contain or contains only a minimal amount of the feedback sound component.
(3) The gain amplification operation is performed on the error signal e to obtain the amplified signal e′, i.e., e′=e*G, where G represents the gain amplification factor.
(4) The amplified signal e′ is used as the signal to be modulated, and the modulation operation is performed to obtain the first target signal (i.e., the driving signal u for the next moment), i.e., u=e′*M, where M represents the transfer function corresponding to the modulation operation.

FIG. 6 is a schematic diagram of the design of an acoustic system provided in some exemplary embodiments of this disclosure. As shown in FIG. 6, the modulation unit 180 may be located before the gain amplification unit 130. In this case, the process in which the signal processing circuit 150 performs the target operation is as follows:
(1) The signal processing circuit 150 obtains the driving signal u internally and acquires the pickup signal y from the pickup component 120.
(2) Based on the driving signal u, the filtering operation is performed on the pickup signal y to obtain the error signal e.

Specifically, referring to FIG. 6, the predictive transfer function F′ is used to perform adaptive filtering on the driving signal u to obtain the signal x′, i.e., x′=u*F′. The signal x′ can be regarded as the predicted value of the feedback component in the pickup signal y (i.e., the signal component in the pickup signal y corresponding to the first sound). Subsequently, the signal x′ is subtracted from the pickup signal y to obtain the error signal e, i.e., e=y−x′=y−u*F′. In this way, the obtained error signal e does not contain or contains only a minimal amount of the feedback sound component.
(3) The error signal e is used as the signal to be modulated, and the modulation operation is performed to obtain the modulated signal e′.

That is, e′=e*M, where M represents the transfer function corresponding to the modulation operation.
(4) The modulated signal e′ is subjected to the gain amplification operation to obtain the first target signal (i.e., the driving signal u for the next moment), i.e., u=e′*G, where G represents the gain amplification factor.

Based on the schemes shown in FIGS. 5 and 6, according to the theory of the adaptive filtering algorithm, the update method of the predictive transfer function F′ can be achieved by minimizing the expected mean square function of the target signal e, i.e.:

$${min}_{{F}^{′}} E [ {e}^{2} ] = {min}_{{F}^{′}} E [ {( y - u * {F}^{′} )}^{2} ] \qquad Formula ( 1 - 1 )$$

Taking the case where the filtering unit 170 adopts the LMS algorithm as an example, and deriving the above formulas (1-2) based on the gradient descent optimization method, the update formula for the predictive transfer function F′ can be obtained as follows:

$${F}^{′} ← {F}^{′} + μ * e * u \qquad Formula ( 2 - 1 )$$

From this, it can be seen that after obtaining the first target signal u, the signal processing circuit 150 can update the predictive transfer function F′ (i.e., update the parameters of the filtering operation) based on the first target signal u according to the above formula (2-2) to cause the filtering operation to converge.

In the solutions shown in FIGS. 5 and 6, the signal processing circuit 150, by performing the modulation operation, ensures that the first target signal u output to the sounding component 110 always operates within the linear response range of the N target devices. It can be understood that when the N target devices include all the devices in the sounding component 110 and the pickup component 120, this is equivalent to eliminating all nonlinear response components in the feedback path; when the N target devices include only part of the devices in the sounding component 110 and the pickup component 120, this is equivalent to reducing the nonlinear response components in the feedback path. Therefore, in the schemes shown in FIGS. 5 and 6, no or fewer nonlinear response components are introduced into the solution of the predictive transfer function F′, thereby improving the convergence performance of the filtering operation and, in turn, enhancing the feedback sound cancellation effect.

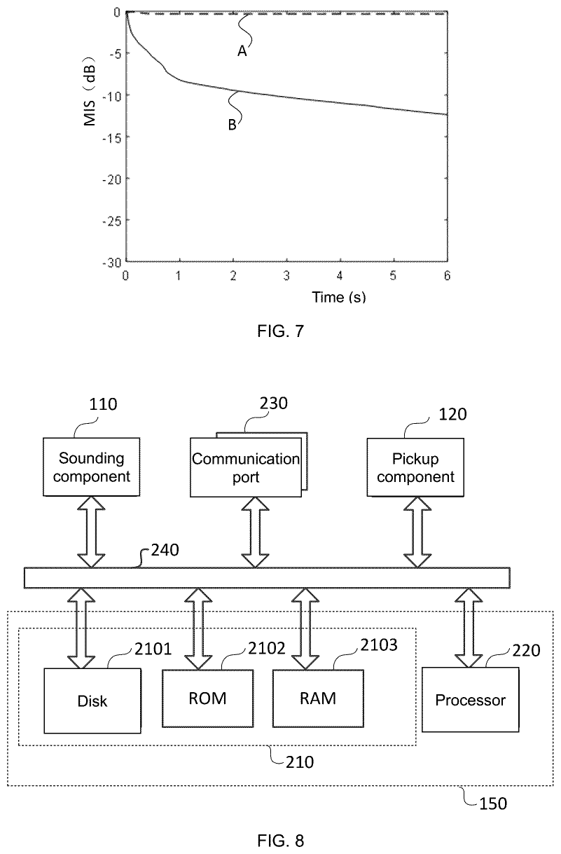

FIG. 7 shows the test results of an acoustic system provided in some exemplary embodiments of this disclosure with respect to filtering performance. Referring to FIG. 7, in the case where the speaker 111 in the acoustic system has a limited amplitude characteristic, when the scheme shown in FIG. 2 is used, the calculated offset is shown by curve A. When the scheme shown in FIG. 4 is used, the calculated offset is shown by curve B. The method of calculating the offset has been described earlier, so it will not be reiterated here. From FIG. 7, it can be seen that the scheme shown in FIG. 4 shows significant improvement in both the convergence degree and the convergence speed of the adaptive filtering algorithm. It should be noted that FIG. 7 only illustrates the comparison of the test results between the schemes shown in FIGS. 2 and 4. The schemes shown in FIGS. 5 and 6 also show significant improvement in the convergence degree and speed of the adaptive filtering algorithm compared to the scheme shown in FIG. 2, although these are not shown in the figure.

The signal processing circuit 150 can be configured to execute the signal processing method described in the embodiments of this disclosure. In some exemplary embodiments, the signal processing circuit 150 may include multiple hardware circuits connected to each other, with each hardware circuit including one or more electrical components that, when operating, implement one or more steps of the signal processing method described in this disclosure. For example, the filtering operation, modulation operation, and gain amplification operation can be implemented by different hardware circuits or electrical components. These multiple hardware circuits work together to implement the signal processing method described in this disclosure. In some exemplary embodiments, the signal processing circuit 150 may also include hardware devices with data processing functions and the necessary programs to drive these devices. The hardware devices execute the programs to implement the signal processing method described in the embodiments of this disclosure. The signal processing method will be described in detail in the following sections.

FIG. 8 is a schematic diagram of the hardware structure of an acoustic system provided in some exemplary embodiments of this disclosure. As shown in FIG. 8, the signal processing circuit 150 may include: at least one storage medium 210 and at least one processor 220. The at least one processor 220 is communicatively connected to the sounding component 110 and the pickup component 120. It should be noted that, for the sake of illustration, the embodiments of this disclosure show that the signal processing circuit 150 includes at least one storage medium 210 and at least one processor 220. A person skilled in the art will understand that the signal processing circuit 150 can also include other hardware circuit structures, and the embodiments of this disclosure are not limited in this regard, as long as the structure can meet the functions mentioned in the embodiments of this disclosure without deviating from the spirit of the embodiments.

Continuing to refer to FIG. 8, in some exemplary embodiments, the acoustic system may also include a communication port 230. The communication port 230 is used for data communication between the acoustic system and the outside world. For example, the communication port 230 can be used for data communication between the acoustic system and other devices/systems. In some exemplary embodiments, the acoustic system may also include an internal communication bus 240. The internal communication bus 240 can connect different system components. For example, the sounding component 110, pickup component 120, processor 220, storage medium 210, and communication port 230 can all be connected via the internal communication bus 240.

The storage medium 210 may include a data storage device. The data storage device can be a non-transitory storage medium or a transitory storage medium. For example, the data storage device may include one or more of a disk 2101, a read-only memory (ROM) 2102, or a random access memory (RAM) 2103. The storage medium 210 also includes at least one instruction set stored in the data storage device. The instruction set includes instructions, which are computer program code, and the computer program code may include programs, routines, objects, components, data structures, processes, modules, etc., that execute the signal processing methods provided in the embodiments of this disclosure.

The at least one processor 220 is used to execute the above-mentioned instruction set. When the acoustic system is operating, the at least one processor 220 reads the instruction set and, based on the instructions in the set, executes the signal processing methods provided in the embodiments of this disclosure. The processor 220 can execute all or part of the steps contained in the signal processing methods. The processor 220 may be in the form of one or more processors. In some exemplary embodiments, the processor 220 may include one or more hardware processors, such as a microcontroller, microprocessor, reduced instruction set computer (RISC), application-specific integrated circuit (ASIC), application-specific instruction set processor (ASIP), central processing unit (CPU), graphics processing unit (GPU), physical processing unit (PPU), microcontroller unit, digital signal processor (DSP), field-programmable gate array (FPGA), advanced RISC machine (ARM), programmable logic device (PLD), or any circuit or processor capable of performing one or more functions, or any combination thereof. For illustration purposes, the acoustic system shown in FIG. 8 illustrates the case where it includes only one processor 220. However, it should be noted that the acoustic system provided in the embodiments of this disclosure may also include multiple processors. Therefore, the operations and/or method steps disclosed in the embodiments of this disclosure may be executed by a single processor or jointly by multiple processors. For example, if the processor 220 of the acoustic system in the embodiments of this disclosure performs step A and step B, it should be understood that step A and step B may also be executed jointly or separately by two different processors 220 (e.g., the first processor performs step A, the second processor performs step B, or both the first and second processors jointly execute steps A and B).

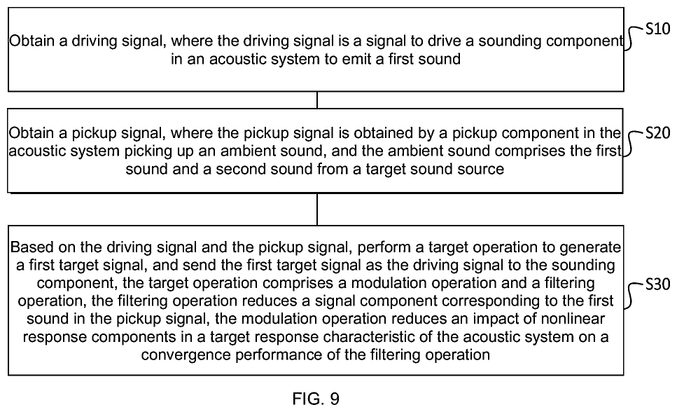

FIG. 9 is a flowchart of a signal processing method provided in some exemplary embodiments of this disclosure. As mentioned earlier, the signal processing circuit 150 in the acoustic system can execute the signal processing method P100 provided in this disclosure. Specifically, the processor 220 can read the instruction set stored in its local storage medium and then execute the signal processing method P100 according to the instructions. As shown in FIG. 9, the signal processing method P100 may include:
S10: Obtain a driving signal, where the driving signal is a signal to drive a sounding component in an acoustic system to emit a first sound.
S20: Obtain a pickup signal, where the pickup signal is obtained by a pickup component in the acoustic system picking up an ambient sound, and the ambient sound comprises the first sound and a second sound from a target sound source.

It should be understood that the execution order of S10 and S20 can be arbitrary. For example, the signal processing circuit 150 may first execute S10 and then execute S20, or it may first execute S20 and then execute S10, or S10 and S20 may be executed in parallel.
S30: Based on the driving signal and the pickup signal, perform a target operation to generate a first target signal, and send the first target signal as the driving signal to the sounding component, the target operation comprises a modulation operation and a filtering operation, the filtering operation reduces a signal component corresponding to the first sound in the pickup signal, the modulation operation reduces an impact of nonlinear response components in a target response characteristic of the acoustic system on a convergence performance of the filtering operation.

In some exemplary embodiments, the sounding component comprises: a speaker, and a first peripheral circuit comprising at least one first peripheral device; the pickup component comprises: a sound sensor, and a second peripheral circuit comprising at least one second peripheral device; and the target response characteristic characterizes a response characteristic of at least one target device, the at least one target device comprises at least one of the speaker, the sound sensor, the at least one first peripheral device, and the at least one second peripheral device.

In some exemplary embodiments, the target response characteristic comprises at least M nonlinear response components, where M is an integer greater than or equal to 1; and the modulation operation is configured to modulate a signal to be modulated by simulating the M nonlinear response components.

In some exemplary embodiments, the target operation further comprises a gain amplification operation; and the executing of the target operation based on the driving signal and the pickup signal to generate the first target signal comprises: using the driving signal as the signal to be modulated to execute the modulation operation and obtain a modulated signal, based on the modulated signal, performing the filtering operation on the pickup signal to obtain a residual signal, and performing the gain amplification operation on the residual signal to obtain the first target signal.

In some exemplary embodiments, after obtaining the first target signal, the method further comprises: executing the modulation operation on the first target signal to obtain a second target signal; and updating parameters of the filtering operation based on the second target signal to cause the filtering operation to converge.

In some exemplary embodiments, the M nonlinear response components originate from N target devices in the acoustic system, where N is an integer greater than or equal to 1; and the modulation operation is configured to simulate the M nonlinear response components with a target response model, where the target response model is obtained by measuring response data of the N target devices and jointly modeling the response data of the N target devices, or the target response model comprises N sub-response models corresponding to the N target devices, where an i-th sub-response model is obtained by measuring response data of an i-th target device and modeling the response data of the i-th target device, and i is a positive integer less than or equal to N.

In some exemplary embodiments, the target response characteristic comprises linear features, the linear features correspond to linear response intervals of the N target devices in the acoustic system, and N is an integer greater than or equal to 1; and the modulation operation is configured to modulate a signal to be modulated based on the linear features so that a modulated signal corresponds to the linear response intervals.

In some exemplary embodiments, the target operation further comprises a gain amplification operation; and the executing of the target operation based on the driving signal and the pickup signal to generate the first target signal comprises: based on the driving signal, performing the filtering operation on the pickup signal to obtain a residual signal; performing the gain amplification operation on the residual signal to obtain an amplified signal; and using the amplified signal as the signal to be modulated to perform the modulation operation, so as to obtain the first target signal.

In some exemplary embodiments, the target operation further comprises a gain amplification operation; and the executing of the target operation based on the driving signal and the pickup signal to generate the first target signal comprises: based on the driving signal, performing the filtering operation on the pickup signal to obtain a residual signal; using the residual signal as the signal to be modulated to perform the modulation operation so as to obtain the modulated signal; and performing the gain amplification operation on a modulated signal to obtain the first target signal.

In some exemplary embodiments, after obtaining the first target signal, the method further comprises: updating parameters of the filtering operation based on the first target to cause the filtering operation to converge.

In some exemplary embodiments, the linear features are obtained by measuring the response data of the N target devices and performing joint modeling on the response data of the N target devices to obtain the linear features; or the linear features are obtained by measuring response data of the N target devices, modeling the response data of each target device separately to obtain N sub-signal features corresponding to the N target devices, and determining the linear features based on the N sub-signal features.

In some exemplary embodiments, the filtering operation comprises an adaptive filtering operation; and the modulation operation comprises at least one of an amplitude modulation, a phase modulation, a frequency modulation, or a filtering modulation.

It should be noted that the detailed implementation of the signal processing method P100 can be referred to in the relevant descriptions of the acoustic system earlier in this document. Its implementation principles and technical effects are similar, and therefore, will not be repeated herein.

In summary, in the solution provided in this document, when the sounding component in the acoustic system operates, it converts the driving signal into the first sound. The pickup component, when operating, picks up the environmental sound and generates the pickup signal, where the environmental sound includes the first sound and the second sound from the target sound source. The signal processing circuit is connected to both the sounding component and the pickup component. During operation, it performs the target operation based on the driving signal and the pickup signal to generate the first target signal, which is then sent as the driving signal to the sounding component. The target operation includes at least the modulation operation and the filtering operation. Since the filtering operation reduces the signal components corresponding to the first sound in the pickup signal, the solution provided in this document can reduce or eliminate feedback sound, thereby avoiding issues such as howling caused by feedback and helping to increase the maximum sound gain that the acoustic system can achieve. Furthermore, since the modulation operation reduces the impact of nonlinear response components in the target response characteristic of the acoustic system on the convergence performance of the filtering operation, the solution provided in this document also enhances the convergence performance of the filtering operation, further improving the cancellation effect of the feedback sound.

This disclosure also provides a non-transitory storage medium that stores at least one set of executable instructions for signal processing. When the executable instructions are executed by a processor, the instructions guide the processor to perform the steps of the signal processing method P100 described in this document. In some possible implementations, the various aspects of this document may also be implemented in the form of a program product that includes program code. When this program product runs on an acoustic system, the program code enables the acoustic system to perform the steps of the signal processing method P100 described in this document. The program product used to implement the above method may be in the form of a portable compact disc read-only memory (CD-ROM) that includes program code, and it can run on the acoustic system. However, the program product in this document is not limited to this, as the readable storage medium can be any tangible medium that contains or stores the program, which can be used or combined with an instruction-execution system. The program product can be composed of one or more readable media in any combination. A readable medium can be either a readable signal medium or a readable storage medium. A readable storage medium may include, but is not limited to, electric, magnetic, optical, electromagnetic, infrared, or semiconductor systems, devices, or components, or any combination of these. More specific examples of readable storage media include: electric connections with one or more wires, portable disks, hard drives, random-access memory (RAM), read-only memory (ROM), erasable programmable read-only memory (EPROM or flash memory), optical fibers, portable compact disc read-only memories (CD-ROMs), optical storage devices, magnetic storage devices, or any suitable combination thereof. The computer-readable storage medium may include data signals that are propagated as part of a carrier, in which the readable program code is carried. Such propagated data signals can take various forms, including but not limited to electromagnetic signals, optical signals, or any suitable combination thereof. A readable storage medium can also be any readable medium other than a readable storage medium, which can transmit, propagate, or transport programs for use or in combination with an instruction-execution system, device, or apparatus. The program code contained on the readable storage medium can be transmitted through any appropriate medium, including but not limited to wireless, wired, optical fiber, RF, or any suitable combination thereof. The program code can be written in any combination of one or more programming languages, including object-oriented programming languages such as Java, C++, etc., and conventional procedural programming languages such as C or similar languages. The program code can be fully executed on the acoustic system, partially executed on the acoustic system, executed as an independent software package, partially executed on the acoustic system and partially on a remote computing device, or fully executed on a remote computing device.

The above description pertains to specific embodiments of the present disclosure. Other embodiments are within the scope of the appended claims. In some cases, the actions or steps described in the claims can be performed in a sequence different from the one in the embodiments and still achieve the desired result. Additionally, the processes depicted in the drawings do not necessarily require a specific order or continuous sequence to achieve the desired outcome. In certain embodiments, multitasking and parallel processing are also possible or may be beneficial.

In summary, after reading this detailed disclosure, a person skilled in the art can understand that the aforementioned detailed disclosure is presented only by way of example and is not intended to be limiting. Although not explicitly stated here, a person skilled in the art will appreciate that the disclosure encompasses various reasonable alterations, improvements, and modifications to the embodiments. These alterations, improvements, and modifications are intended to be within the spirit and scope of the exemplary embodiments presented in this disclosure.

In addition, certain terms in this disclosure have been used to describe the embodiments of the disclosure. For example, the terms “one embodiment,” “embodiment,” and/or “some exemplary embodiments” mean that specific features, structures, or characteristics described in connection with that embodiment may be included in at least one embodiment of the disclosure. Therefore, it should be emphasized and understood that references to “embodiment,” “one embodiment,” or “alternative embodiment” in various parts of this disclosure do not necessarily refer to the same embodiment. Additionally, specific features, structures, or characteristics may be appropriately combined in one or more embodiments of the disclosure.

It should be understood that in the foregoing description of the embodiments of the disclosure, in order to aid in understanding a feature and simplify the presentation, various features are combined in a single embodiment, drawing, or description. However, this does not mean that the combination of these features is required. A person skilled in the art, upon reading this disclosure, could very well consider part of the equipment marked as a separate embodiment. In other words, the embodiments in this disclosure can also be understood as the integration of multiple sub-embodiments. And each sub-embodiment is valid even when it includes fewer features than a single full embodiment disclosed above.

Each patent, patent application, publication of a patent application, and other materials, such as articles, books, disclosures, publications, documents, articles, etc., cited herein, except for any historical prosecution documents to which it relates, which may be inconsistent with or any identities that conflict, or any identities that may have a restrictive effect on the broadest scope of the claims, are hereby incorporated by reference for all purposes now or hereafter associated with this document. Furthermore, in the event of any inconsistency or conflict between the description, definition, and/or use of a term associated with any contained material, the term used in this document shall prevail.

Finally, it should be understood that the embodiments of the application disclosed herein are illustrative of the principles of the embodiments of this disclosure. Other modified embodiments are also within the scope of this disclosure. Therefore, the embodiments disclosed in this disclosure are merely examples and not limitations. A person skilled in the art can adopt alternative configurations based on the embodiments in this disclosure to implement the application in this disclosure. Thus, the embodiments of this disclosure are not limited to the embodiments described in the application in precise detail.

What is claimed is:

1. An acoustic system, comprising:
a sounding component, configured to convert a driving signal into a first sound;
a pickup component, configured to pick up an ambient sound and generate a pickup signal, wherein the ambient sound comprises the first sound and a second sound from a target sound source; and
a signal processing circuit, connected to the sounding component and the pickup component, and configured to:
execute a target operation based on the driving signal and the pickup signal to generate a first target signal, and
send the first target signal as the driving signal to the sounding component, wherein
the target operation at least comprises a modulation operation and a filtering operation,
the filtering operation reduces a signal component corresponding to the first sound in the pickup signal, and
the modulation operation reduces an impact of nonlinear response components in a target response characteristic of the acoustic system on a convergence performance of the filtering operation.

2. The acoustic system according to claim 1, wherein
the sounding component comprises:
a speaker, and
a first peripheral circuit, connected to the speaker and the signal processing circuit, and comprising at least one first peripheral device;
the pickup component comprises:
a sound sensor, and
a second peripheral circuit, connected to the sound sensor and the signal processing circuit, and comprising at least one second peripheral device; and
the target response characteristic characterizes a response characteristic of at least one target device, the at least one target device comprises at least one of the speaker, the sound sensor, the at least one first peripheral device, or the at least one second peripheral device.

3. The acoustic system according to claim 1, wherein the target response characteristic comprises at least M nonlinear response components, wherein M is an integer greater than or equal to 1; and
the modulation operation is configured to modulate a signal to be modulated by simulating the M nonlinear response components.

4. The acoustic system according to claim 3, wherein the target operation further comprises a gain amplification operation; and when the signal processing circuit performs the target operation:
the driving signal is used as the signal to be modulated to execute the modulation operation and obtain a modulated signal,
based on the modulated signal, the filtering operation is performed on the pickup signal to obtain a residual signal, and
the gain amplification operation is performed on the residual signal to obtain the first target signal.

5. The acoustic system according to claim 4, wherein after obtaining the first target signal, the signal processing circuit further performs:
executing the modulation operation on the first target signal to obtain a second target signal; and
updating parameters of the filtering operation based on the second target signal to cause the filtering operation to converge.

6. The acoustic system according to claim 3, wherein the M nonlinear response components originate from N target devices in the acoustic system, wherein N is an integer greater than or equal to 1; and
the modulation operation is configured to simulate the M nonlinear response components with a target response model, wherein
the target response model is obtained by measuring response data of the N target devices and jointly modeling the response data of the N target devices, or
the target response model comprises N sub-response models corresponding to the N target devices, wherein an i-th sub-response model is obtained by measuring response data of an i-th target device and modeling the response data of the i-th target device, and i is a positive integer less than or equal to N.

7. The acoustic system according to claim 1, wherein the target response characteristic comprises linear features, the linear features correspond to linear response intervals of the N target devices in the acoustic system, and N is an integer greater than or equal to 1; and
the modulation operation is configured to modulate a signal to be modulated based on the linear features so that a modulated signal corresponds to the linear response intervals.

8. The acoustic system according to claim 7, wherein the target operation further comprises a gain amplification operation, and when the signal processing circuit executes the target operation: based on the driving signal, the filtering operation is performed on the pickup signal to obtain a residual signal, the gain amplification operation is performed on the residual signal to obtain an amplified signal, and the amplified signal is used as the signal to be modulated to perform the modulation operation, so as to obtain the first target signal; or
the target operation further comprises a gain amplification operation, and when the signal processing circuit executes the target operation: based on the driving signal, the filtering operation is performed on the pickup signal to obtain a residual signal, the residual signal is used as the signal to be modulated to perform the modulation operation so as to obtain the modulated signal, and the gain amplification operation is performed on a modulated signal to obtain the first target signal.

9. The acoustic system according to claim 8, wherein after obtaining the first target signal, the signal processing circuit further performs:
updating parameters of the filtering operation based on the first target to cause the filtering operation to converge.

10. The acoustic system according to claim 7, wherein
the linear features are obtained by measuring the response data of the N target devices and performing joint modeling on the response data of the N target devices to obtain the linear features; or
the linear features are obtained by measuring response data of the N target devices, modeling the response data of each target device separately to obtain N sub-signal features corresponding to the N target devices, and determining the linear features based on the N sub-signal features.

11. A signal processing method, comprising, by a signal processing circuit in an acoustic system:
obtaining a driving signal configured to drive a sounding component in the acoustic system to emit a first sound;
obtaining a pickup signal by picking up an ambient sound by a pickup component in the acoustic system, the ambient sound comprising the first sound and a second sound from a target sound source; and
performing a target operation based on the driving signal and the pickup signal to generate a first target signal, and sending the first target signal as the driving signal to the sounding component, wherein
the target operation comprises a modulation operation and a filtering operation,
the filtering operation reduces a signal component corresponding to the first sound in the pickup signal, and
the modulation operation reduces an impact of nonlinear response components in target response characteristic of the acoustic system on a convergence performance of the filtering operation.

12. The method according to claim 11, wherein
the sounding component comprises:
a speaker, and
a first peripheral circuit comprising at least one first peripheral device;
the pickup component comprises:
a sound sensor, and
a second peripheral circuit comprising at least one second peripheral device; and
the target response characteristic characterizes a response characteristic of at least one target device, the at least one target device comprises at least one of the speaker, the sound sensor, the at least one first peripheral device, or the at least one second peripheral device.

13. The method according to claim 11, wherein the target response characteristic comprises at least M nonlinear response components, wherein M is an integer greater than or equal to 1; and
the modulation operation is configured to modulate a signal to be modulated by simulating the M nonlinear response components.

14. The method according to claim 13, wherein the target operation further comprises a gain amplification operation; and the executing of the target operation based on the driving signal and the pickup signal to generate the first target signal comprises:
using the driving signal as the signal to be modulated to execute the modulation operation and obtain a modulated signal,
based on the modulated signal, performing the filtering operation on the pickup signal to obtain a residual signal, and
performing the gain amplification operation on the residual signal to obtain the first target signal.

15. The method according to claim 14, further comprising: after obtaining the first target signal:
executing the modulation operation on the first target signal to obtain a second target signal; and
updating parameters of the filtering operation based on the second target signal to cause the filtering operation to converge.

16. The method according to claim 13, wherein
the M nonlinear response components originate from N target devices in the acoustic system, wherein N is an integer greater than or equal to 1; and
the modulation operation is configured to simulate the M nonlinear response components with a target response model, wherein
the target response model is obtained by measuring response data of the N target devices and jointly modeling the response data of the N target devices, or
the target response model comprises N sub-response models corresponding to the N target devices, wherein an i-th sub-response model is obtained by measuring response data of an i-th target device and modeling the response data of the i-th target device, and i is a positive integer less than or equal to N.

17. The method according to claim 11, wherein the target response characteristic comprises linear features, the linear features correspond to linear response intervals of the N target devices in the acoustic system, and N is an integer greater than or equal to 1; and
the modulation operation is configured to modulate a signal to be modulated based on the linear features so that a modulated signal corresponds to the linear response intervals.

18. The method according to claim 17, wherein the target operation further comprises a gain amplification operation, and the executing of the target operation based on the driving signal and the pickup signal to generate the first target signal comprises: based on the driving signal, performing the filtering operation on the pickup signal to obtain a residual signal, performing the gain amplification operation on the residual signal to obtain an amplified signal, and using the amplified signal as the signal to be modulated to perform the modulation operation, so as to obtain the first target signal; or
the target operation further comprises a gain amplification operation, and the executing of the target operation based on the driving signal and the pickup signal to generate the first target signal comprises: based on the driving signal, performing the filtering operation on the pickup signal to obtain a residual signal, using the residual signal as the signal to be modulated to perform the modulation operation so as to obtain the modulated signal, and performing the gain amplification operation on a modulated signal to obtain the first target signal.

19. The method according to claim 18, further comprising: after obtaining the first target signal:
updating parameters of the filtering operation based on the first target to cause the filtering operation to converge.

20. The method according to claim 17, wherein
the linear features are obtained by measuring the response data of the N target devices and performing joint modeling on the response data of the N target devices to obtain the linear features; or
the linear features are obtained by measuring response data of the N target devices, modeling the response data of each target device separately to obtain N sub-signal features corresponding to the N target devices, and determining the linear features based on the N sub-signal features.
